(19) United States
(12) Patent Application Publication
(10) Pub. No.: US 2022/0144448 A1
(43) Pub. Date: May 12, 2022

(54) METHOD OF DETERMINING WARNING THRESHOLD FOR AN AIRCRAFT SAFETY SYSTEM

(71) Applicant: Safe Flight Instrument, LLC, White Plains, NY (US)

(72) Inventors: Randall A. Greene, White Plains, NY (US); Patrick T. Morgan, Tarrytown, NY (US); Louis C. Simons, White Plains, NY (US)

(73) Assignee: Safe Flight Instrument, LLC, White Plains, NY (US)

(21) Appl. No.: 17/373,614

(22) Filed: Jul. 12, 2021

Related U.S. Application Data
(60) Provisional application No. 63/050,724, filed on Jul. 10, 2020.

(51) Int. Cl. B64D 45/00; G01P 1/00; G08B 21/18

(52) U.S. Cl. CPC B64D 45/00; G08B 21/182; G01P 1/06

(57) ABSTRACT

Disclosed herein are novel methods of determining and/or adjusting warning thresholds for an aircraft safety system. One exemplary method of adjusting warning thresholds for an aircraft safety system includes determining an acceptable vertical speed range for an aircraft during takeoff or landing and measuring the aircraft's indicated airspeed and true airspeed. The method further includes determining the relationship between the indicated airspeed and the true airspeed, and using such relationship to adjust the acceptable vertical speed range.

### CROSS-REFERENCE TO RELATED APPLICATIONS

This application claims priority to U.S. Provisional Patent Application No. 63/050,724 titled “Density Altitude Adjustment” and filed on Jul. 10, 2020, the disclosures of this patent application being incorporated herein by reference in their entirety.

### FIELD OF INVENTION

The present disclosure generally relates to novel methods for determining and/or adjusting the warning threshold for an aircraft safety system. More specifically, the present disclosure relates to novel methods for determining and/or adjusting the warning threshold with regard to vertical speed of an aircraft during takeoff and landing by accounting for density attitude.

### BACKGROUND

Typically, modern aircraft are equipped with safety systems that include audible or visual warnings that are triggered when certain operational thresholds are surpassed. One critical safety parameter of an aircraft is the speed of the aircraft. Each aircraft is designed to operate within certain speed ranges, where such speed ranges are particularly critical for certain activities such as takeoff and landing the aircraft. As a pilot operates an aircraft, it is important for the pilot to accurately understand the speed of the aircraft. This includes both the vertical and horizontal components of aircraft speed. To assure safe operation of the aircraft, safety systems will alert the pilot when the aircraft is approaching or surpasses a specific speed threshold.

Primarily, an aircraft's systems use indicated airspeed (“IAS”) to estimate and inform the pilot of the speed of the aircraft, and to warn the pilot in case the aircraft is approaching or surpasses a speed threshold. As an alternative, aircraft systems can also use calibrated airspeed (CAS) in place of IAS. Generally speaking, CAS is IAS that is corrected for instrument and position error. However, neither IAS nor CAS necessarily represent the speed of the aircraft as it moves through the air or relative the ground. Instead IAS and CAS represents the performance of the aircraft based on dynamic pressure. Thus, using IAS or CAS can lead to inaccurate estimations of the actual speed of the aircraft. Such inaccurate estimates may lead to an aircraft's safety systems issuing warnings prematurely or not issuing a warning at all despite the aircraft nearing or actually surpassing a threshold. Such premature or non-issued warnings can imperil the aircraft, its passengers and crew, and its cargo. This is particularly true during takeoff and landing of the aircraft, where the vertical and horizontal components of the aircraft speed are critical in the aircraft successfully taking off and landing.

There is a need in the aviation industry for methods that more accurately estimate the speed of aircraft, and in particular, the vertical speed of an aircraft, to insure that the safety systems and pilot of the aircraft receive efficient and accurate information to safely operate the aircraft.

### SUMMARY

Disclosed herein are novel methods of determining and/or adjusting control parameters, such as a coefficient of a warning threshold, for an aircraft safety system. One exemplary method of adjusting warning thresholds for an aircraft safety system includes determining an acceptable vertical speed range for an aircraft during takeoff or landing and measuring the aircraft's indicated airspeed and true airspeed. The method further includes determining the relationship between the indicated airspeed and the true airspeed, and using such relationship to adjust the acceptable vertical speed range.

### BRIEF DESCRIPTION OF THE DRAWINGS

In the accompanying drawings, structures are illustrated that, together with the detailed description provided below, describe example embodiments of the disclosed systems, methods, and apparatus. Where appropriate, like elements are identified with the same or similar reference numerals. Elements shown as a single component can be replaced with multiple components. Elements shown as multiple components can be replaced with a single component. The drawings may not be to scale. The proportion of certain elements may be exaggerated for the purpose of illustration.

FIG. 1 is a chart that illustrates the ratio of TAS to IAS increases generally linearly with the increase in density altitude.

FIG. 2 is a chart that illustrates sink rates in feet per minute.

FIG. 3 is a chart that illustrates sink rates in feet per second.

FIG. 4 is a chart that illustrates the increase in sink rates as comparted to sea level in feet per minute.

FIG. 5 is a chart that illustrates the increase in sink rates as comparted to sea level in feet per second.

### DETAILED DESCRIPTION

The apparatus, systems, arrangements, and methods disclosed in this document are described in detail by way of examples. It will be appreciated that modifications to disclosed and described examples, arrangements, configurations, components, elements, apparatus, methods, materials, etc. can be made and may be desired for a specific application. In this disclosure, any identification of specific techniques, arrangements, method, etc. are either related to a specific example presented or are merely a general description of such a technique, arrangement, method, etc. Identifications of specific details or examples are not intended to be and should not be construed as mandatory or limiting unless specifically designated as such. Selected examples of apparatus, arrangements, and methods for determining and/or adjusting warning thresholds to account for density altitude are hereinafter disclosed and described in detail with reference made to the charts.

As noted, the primary estimate of airspeed used by aircraft systems is IAS. While the remainder of this disclosure will reference IAS as a source of aircraft airspeed, it will be understood that the principles and teachings of this disclosure also apply to the use of CAS as a source for airspeed. The IAS is referenced by aircraft manufacturers as a basis for its recommendations for takeoff speeds, landing speeds, and stall speeds. Thus, it is a critical factor in the safe operation of an aircraft. The speed at which an aircraft moves relative to an airmass is referred to as true airspeed (TAS). At sea level with a pressure of one standard atmosphere, IAS and TAS are equivalent. Thus, at sea level, the ratio of TAS to IAS is 1. However, at various altitudes above sea level, the ratio of TAS to IAS deviates from 1, generally increasing as altitude increases. Such an increase in the TAS/IAS ratio can be quantified by reference to density altitude. Thus, the ratio of TAS to IAS can be determined according to the relationship shown in the equation below. It is noted that the equation below does not account for compressibility effects. While the equation could use equivalent airspeed (EAS), IAS is used instead because the difference between EAS and IAS is only about one percent at 150 KCAS and an altitude of 10,000 feet.

$$\frac{TAS}{IAS} = \sqrt{\frac{{ρ}_{0}}{ρ ( a )}} \qquad Equation 1$$

where ρ₀ is the air density at sea level and ρ(a) the air density at altitude a, which depends on pressure (P) and temperature (T) at the specific altitude.

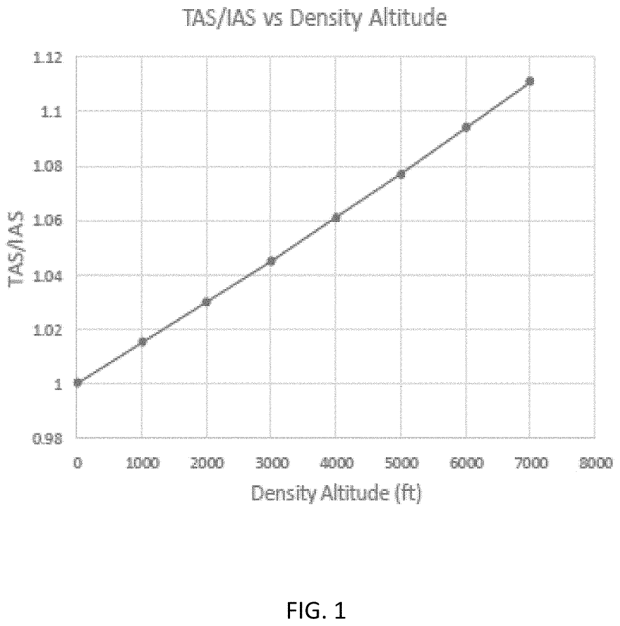

FIG. 1 illustrates a chart that shows the ratio of TAS to IAS increases generally linearly with the increase in density altitude. As density altitude reaches 7000 feet, the ratio of TAS to IAS is more than ten percent higher than the ratio at sea level. As will be appreciated, when the TAS is more than ten percent larger than the IAS used as an estimate of aircraft speed by the aircraft system and pilot during takeoff and, more importantly, landing, such an inaccurate estimate can lead to a tightening of the allowable deviation from the expected vertical speed of the aircraft, which can lead to excessive and unnecessary warnings from the safety systems. As noted, accounting for the density altitude in the determination of thresholds can prevent such unnecessary warnings. It will be further noted that corrections in thresholds due to density altitude can be implemented fully or as a percentage to effectively adjust the thresholds. Such corrections are practical for a variety of uses for aircrafts. For example, many cities serviced by aircraft, such as Santa Fe, N. Mex., Laramie, Wyo., Colorado Springs, Colo., and Denver, Colo., are at or near an elevation of 7000 feet.

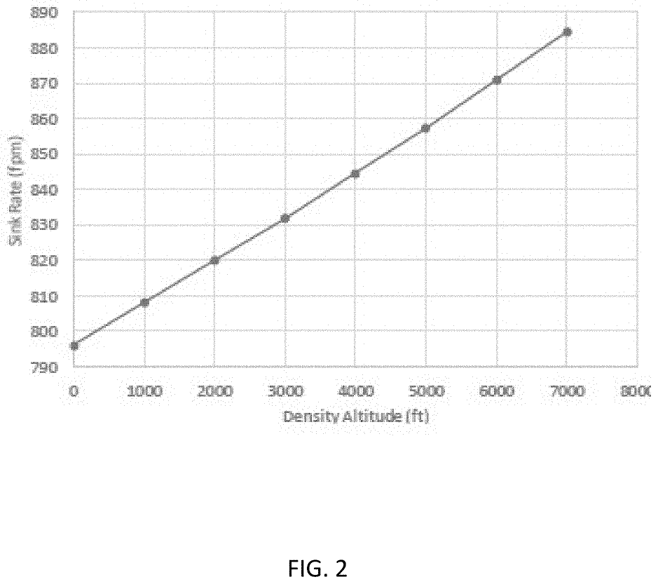

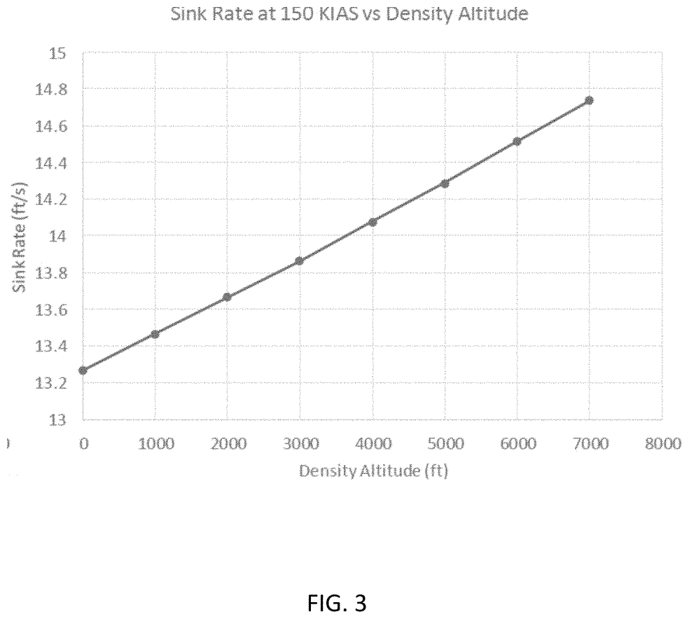

FIGS. 2 and 3 illustrate charts showing sink rates in feet per minute (FIG. 2) and feet per second (FIG. 3) relative to density altitude, where an aircraft is traveling at 150 knots indicated airspeed (KIAS) at a three degree glide-slope angle. As illustrated, under the same KIAS and glide-slope angle, the sink rate at 7000 feet of altitude is approximately 90 feet per minute (or 1.5 feet per second) greater than the sink rate at sea level. In one practical example of sink rate of an aircraft traveling at the same 150 KIAS and three degree glide-slope angle at sea level (such as Newark, N.J.) and at a relatively high elevation (such as Denver, Colo.), the sink rate is 67 feet per minute (1.1 feet per second) greater in Denver, Colo. as compared to Newark, N.J. The 150 KIAS translates to 163 knots true airspeed. Thus, when no adjustment is made, an aircraft landing in Denver, Colo. can generate unnecessary warnings as it descends at 1.5 feet per second faster than anticipated by an estimate reliant on only IAS, which can cause safety issues.

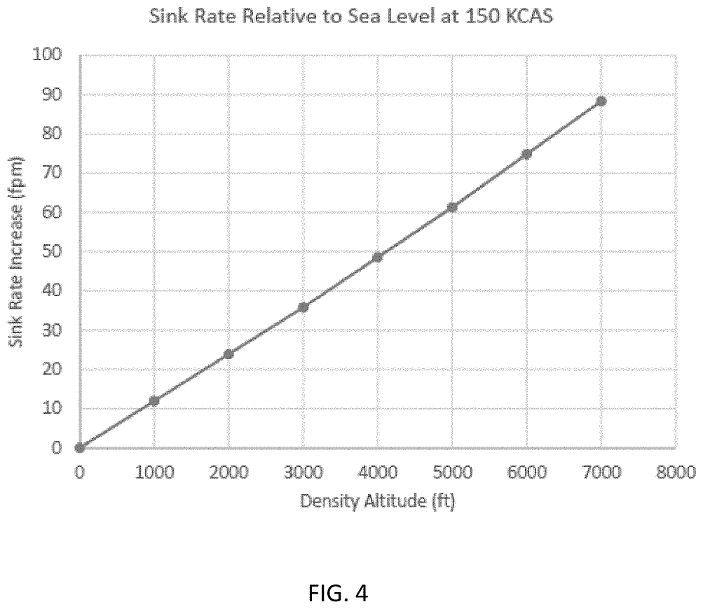

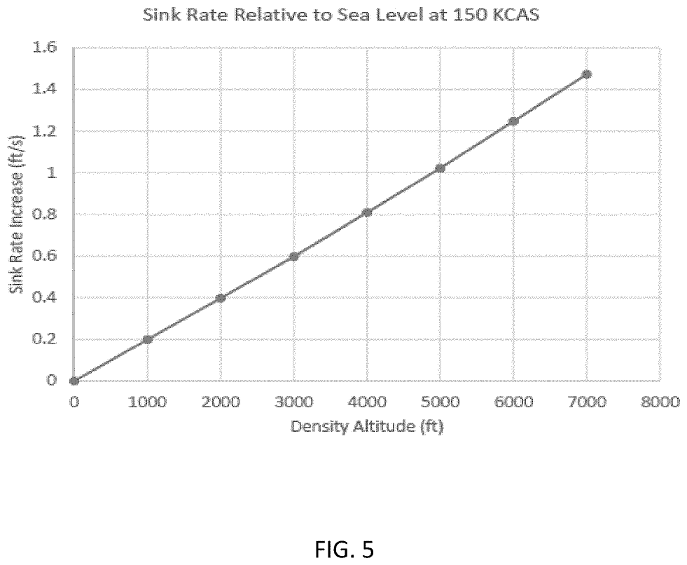

FIGS. 4 and 5 illustrate charts showing the increase in sink rates as comparted to sea level in feet per minute (FIG. 4) and feet per second (FIG. 5) relative to density altitude, where an aircraft is traveling at 150 knots calibrated airspeed (KCAS) at a three degree glide-slope angle. As illustrated in FIGS. 2-5, the increase in sink rate at 7000 feet of altitude relative to sea level is comparable (approximately 90 feet per minute or 1.5 feet per second) to the increase when KIAS is used. Thus, KCAS and KIAS are essentially interchangeable and either can be used with the methods described herein.

When landing an aircraft, a pilot typically operates the aircraft at a fixed landing speed in terms of IAS, which herein will be referred to as IAS_{L}, and a constant glide-slope angle. In still air the vertical component of speed is defined by:

V_{y}=sin(γ)*TAS_{L} Equation 2
where γ is the glide slope angle and TAS_{L} is the true airspeed when operating the aircraft at a fixed speed of IAS_{L}.

As noted above, Equation 1 shows that IAS equals TAS at sea level. If we substitute IAS_{L} for TAS_{L} in Equation 2, the result is:

V_{y0}=sin(γ)*IAS_{L} Equation 3
where V_{y0} is the vertical speed a pilot expects to experience when flying a standard glide-slope angle at sea level.

When close to the ground, it is especially important that the aircraft's systems and pilot carefully and accurately manage vertical speed. Safety systems will generally allow a certain deviation in vertical speed from V_{y0} before issuing a warn to the pilot. Without accounting for the increase in vertical speed resulting from an increased density altitude, the margin from the alerting threshold during a standard approach becomes tighter and safety systems may become prone to premature warnings, which can cause distractions for pilots.

The difference between actual vertical speed (V_{y}) and V_{y0} is the result of the failure to account for density altitude. A proportional density altitude adjustment (DA_{Adj}) can be calculated by subtracting equation 3 from equation 2, as shown below:

DA_{Adj}=sin(γ)*(TAS_{L}−IAS_{L}) Equation 4

Premature warnings can be mitigated by applying this density altitude adjustment to the vertical speed alert threshold.

The foregoing description of examples has been presented for purposes of illustration and description. It is not intended to be exhaustive or limiting to the forms described. Numerous modifications are possible in light of the above teachings. Some of those modifications have been discussed, and others will be understood by those skilled in the art. The examples were chosen and described in order to best illustrate principles of various examples as are suited to particular uses contemplated. The scope is, of course, not limited to the examples set forth herein, but can be employed in any number of applications and equivalent devices by those of ordinary skill in the art.

We claim:

1. A method for adjusting a warning threshold for an aircraft safety system comprises:
determining an acceptable vertical speed range for an aircraft;
measuring the aircraft's indicated airspeed;
measuring the aircraft's true airspeed; and
determining the relationship between the indicated airspeed and the true airspeed, and
using such relationship to adjust the acceptable vertical speed range.

2. The method of claim 1, wherein a glide-slope angle of the aircraft is used in determining the relationship between the indicated airspeed and the true airspeed.

3. The method of claim 1, wherein the acceptable vertical speed range is decreased as a ratio of true airspeed to indicated airspeed increases.
